(19) United States
(12) Patent Application Publication
(10) Pub. No.: US 2007/0081804 A1
(43) Pub. Date: Apr. 12, 2007

(54) Electronic device including a rotatable camera unit

(75) Inventor: Fei-Mi Su, Chang-Hua Hsien (TW)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Universal Scientific Industrial Co., Ltd., Nan-Tou Hsien (TW)

(21) Appl. No.: 11/245,507

(22) Filed: Oct. 7, 2005

(51) Int. Cl. G03B 17/08

(52) U.S. Cl. 396/29

(57) ABSTRACT

An electronic device includes a casing, a camera housing, a coupler, and an elastic member. The casing is formed with a hole therethrough. The coupler has a first end portion that is received rotatably in the hole in the casing, a second end portion that is coupled to the camera housing, and a flange that is disposed between the first and second end portions of the coupler. The flange of the coupler is provided with a protrusion that is in sliding contact with a periphery of the hole in the casing. The elastic member surrounds the first end portion of the coupler, is disposed between and is in airtight contact with the flange of the coupler and the periphery of the hole in the casing, and is in sliding contact with the periphery of the hole in the casing.

### BACKGROUND OF THE INVENTION

1. Field of the Invention

This invention relates to an electronic device, more particularly to an electronic device that includes a camera unit.

2. Description of the Related Art

FIG. 1 illustrates a conventional electronic device 1 that includes a casing 11, a camera unit 12, a coupler 15, and a sealing unit. The casing 11 has a casing wall 111 that is formed with a hole 110 therethrough. The camera unit 12 includes a camera housing 121, an optoelectronic module 122, and an electrical wire unit 125. The camera housing 121 has an opening 120. The optoelectronic module 122 is disposed in the camera housing 121. The electrical wire unit 125 has a first end portion that extends into the camera housing 121 through the opening 120, and a second end portion that extends into the casing 11. The coupler 15 serves to couple pivotably the camera housing 121 to the casing 11. The coupler 15 has a cylindrical end portion 151 that is received rotatably in the hole 110 in the casing 11, and a flange end portion 152 that is opposite to the cylindrical end portion 151 of the coupler 15 and that is coupled to the camera housing 121. The coupler 15 is formed with a hole 150 for extension of the electrical wire unit 125 of the camera unit 12 therethrough. The sealing unit includes first and second O-ring seals 14, 13. The first O-ring seal 14 of the sealing unit is sleeved on the cylindrical end portion 151 of the coupler 15, is disposed between and is in airtight contact with a periphery of the hole 110 in the casing 11 and the flange end portion 152 of the coupler 15, and is in sliding contact with the periphery of the hole 110 in the casing 11. The second O-ring seal 13 of the sealing unit is disposed between and is in airtight contact with a periphery of the opening 120 in the camera housing 121 and the flange end portion 152 of the coupler 15.

The conventional electronic device 1 is disadvantageous in that a large contact area between the first O-ring seal 14 of the sealing unit and the periphery of the hole 110 in the casing wall 111 of the casing 11 aggravates wear of the first O-ring seal 14, which is a result of abrasion when the camera housing 121 is rotated relative to the casing 11. Moreover, friction between the first O-ring seal 14 of the sealing unit and the periphery of the hole 110 in the casing wall 111 of the casing 11 when the camera housing 121 is rotated relative to the casing 11 is a cause of unsmooth rotation of the camera housing 121. Further, since the coupler 15, and the first and second O-ring seals 14, 13 of the sealing unit are separate parts, assembly time for the conventional electronic device 1 is relatively long.

### SUMMARY OF THE INVENTION

Therefore, the object of the present invention is to provide an electronic device that includes a rotatable camera unit and that can overcome the aforesaid drawbacks of the prior art.

According to the present invention, an electronic device comprises a casing, a camera unit, a coupler, and a sealing unit. The casing has a casing wall formed with a hole therethrough. The camera unit includes a camera housing, an optoelectronic module, and an electrical wire unit. The camera housing has an opening. The optoelectronic module is disposed in the camera housing. The electrical wire unit has a first end portion that extends into the camera housing through the opening and that is connected electrically to the optoelectronic module, and a second end portion that extends into the casing. The coupler serves to couple pivotably the camera housing to the casing. The coupler has a first end portion that is received rotatably in the hole in the casing, a second end portion that is coupled to the camera housing, and a flange that is disposed between the first and second end portions of the coupler. The flange of the coupler is provided with a protrusion that is in sliding contact with a periphery of the hole in the casing. The coupler is formed with a hole for extension of the electrical wire unit of the camera unit therethrough. The sealing unit serves to prevent water or vapor from entering the casing. The sealing unit includes an elastic member that surrounds the first end portion of the coupler, that is disposed between and that is in airtight contact with the flange of the coupler and the periphery of the hole in the casing, and that is in sliding contact with the periphery of the hole in the casing.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic sectional view of a conventional electronic device;

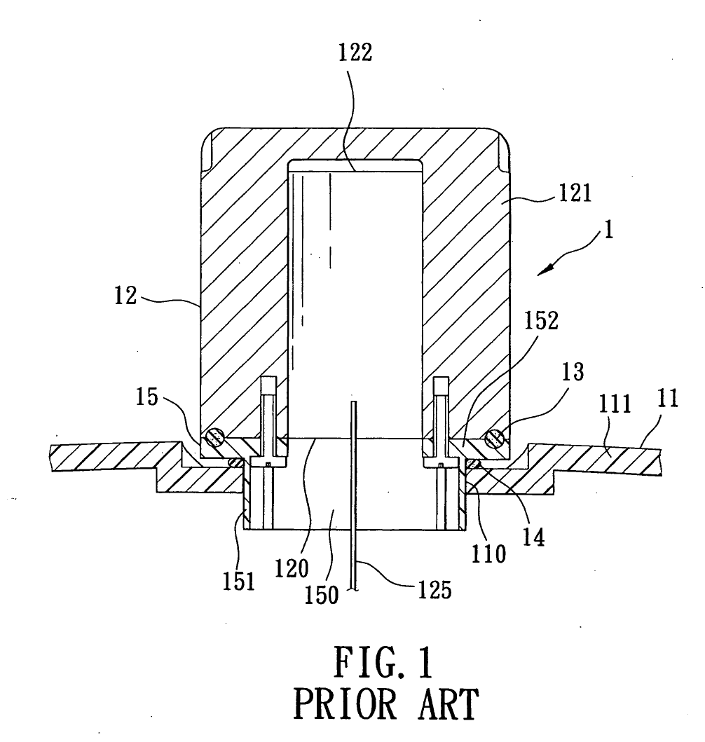

FIG. 2 is a perspective view of the preferred embodiment of an electronic device according to this invention;

FIG. 3 is an exploded perspective view of the preferred embodiment; and

FIG. 4 is a fragmentary schematic sectional view to illustrate a coupler and a sealing unit of the preferred embodiment.

### DETAILED DESCRIPTION OF THE PREFERRED EMBODIMENT

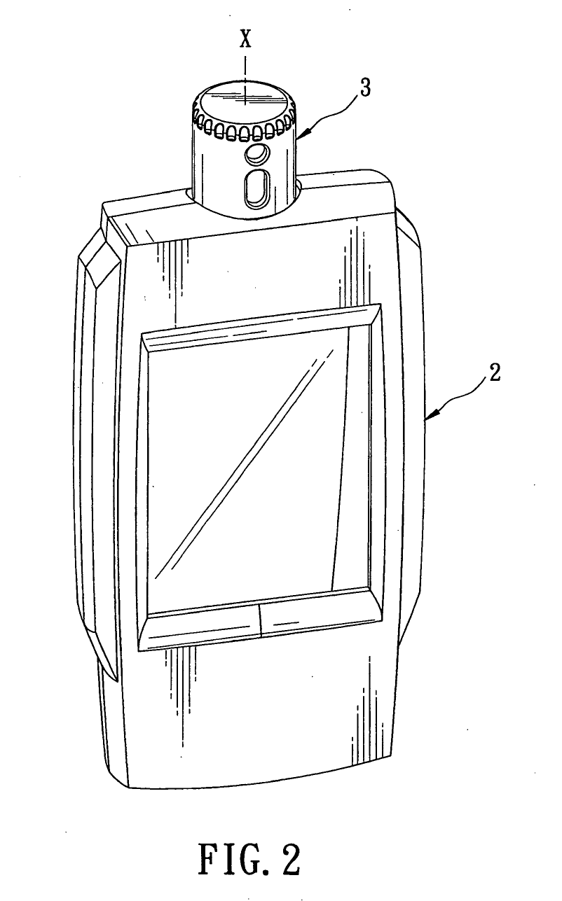

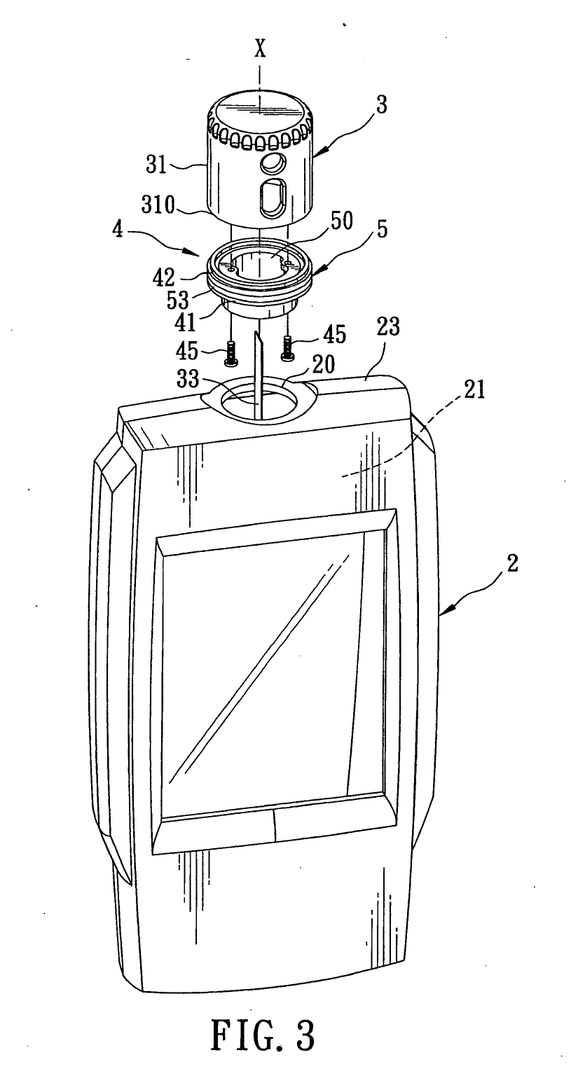

Referring to FIGS. 2 to 4, the preferred embodiment of an electronic device according to this invention is shown to include a casing 2, a camera unit 3, a coupler 5, and a sealing unit 4.

The casing 2 confines an accommodating space 21, and has a casing wall 23 that is formed with a hole 20 therethrough. The hole 20 in the casing wall 23 of the casing 2 has a hole axis (X) and is in spatial communication with the accommodating space 21.

The camera unit 3 includes a camera housing 31, an optoelectronic module 32, and an electrical wire unit 33. The camera housing 31 has an opening 310. The optoelectronic module 32 is disposed in the camera housing 31. The electrical wire unit 33 has a first end portion 331 that extends into the camera housing 31 through the opening 310 and that is connected electrically to the optoelectronic module 32, and a second end portion 332 that extends into the accommodating space 21 in the casing 2.

The coupler 5 serves to couple pivotably the camera housing 31 to the casing 2. In this embodiment, the coupler 5 is generally cylindrical in shape, and has first and second end portions 51, 52 that are opposite to each other along the hole axis (X), and a flange 53 that is disposed between the first and second end portions 51, 52 of the coupler 5. The first end portion 51 of the coupler 5 is received rotatably in the hole 20 in the casing wall 23 of the casing 2. The second end portion 52 of the coupler 5 is coupled to the camera housing 31 of the camera unit 3. In particular, the second end portion 52 of the coupler 5 is formed with a pair of holes therethrough. The electronic device further includes a pair of fastening members 45, each of which extends through a respective one of the holes in the second end portion 52 of the coupler 5 and threadedly engages the camera housing 31 of the camera unit 3. The coupler 5 is formed with a hole 50 for extension of the electrical wire unit 33 of the camera unit 3 therethrough. Preferably, the coupler 5 is made of a plastic material and is rigid.

The sealing unit 4 serves to prevent water or vapor from entering the accommodating space 21 in the casing 2. In this embodiment, the sealing unit 4 includes first and second elastic members 41, 42. The first elastic member 41 of the sealing unit 4 surrounds the first end portion 51 of the coupler 5, and is disposed between and is in airtight contact with the flange 53 of the coupler 5 and a periphery of the hole 20 in the casing wall 23 of the casing 2. On the other hand, the second elastic member 42 of the sealing unit 4 surrounds the second end portion 52 of the coupler 5, and is disposed between and is in airtight contact with the flange 53 of the coupler 5 and a periphery of the opening 310 in the camera housing 31 of the camera unit 3. Preferably, each of the first and second elastic members 41, 42 of the sealing unit 4 is made of a rubber material.

In this embodiment, the first and second elastic members 41, 42 of the sealing unit 4, and the coupler 5 are integrally formed into a single piece through molding techniques. The construction as such shortens assembly time for the electronic device of this invention.

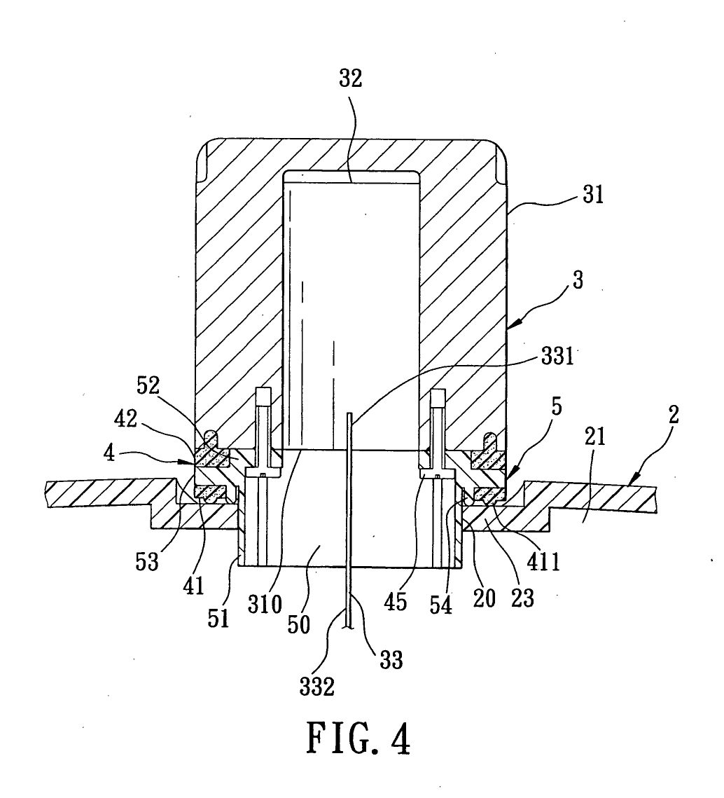

As best shown in FIG. 4, the first elastic member 41 of the sealing unit 4 is formed with a rib 411 that surrounds the first end portion 51 of the coupler 5 and that is in sliding contact with the periphery of the hole 20 in the casing wall 23 of the casing 2. As such, contact area between the first elastic member 41 of the sealing unit 4 and the periphery of the hole 20 in the casing wall 23 of the casing 2 is reduced, thereby reducing friction between the first elastic member 41 of the sealing unit 4 and the periphery of the hole 20 in the casing wall 23 of the casing 2 when the camera housing 31 of the camera unit 3 is rotated relative to the casing 2. In addition, the flange 53 of the coupler 5 is provided with protrusions 54 that are in sliding contact with the periphery of the hole 20 in the casing wall 23 of the casing 2. Accordingly, the friction between the first elastic member 41 of the sealing unit 4 and the periphery of the hole 20 in the casing wall 23 of the casing 2 when the camera housing 31 of the camera unit 3 is rotated relative to the casing 2 is further reduced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electronic device, comprising:
a casing having a casing wall formed with a hole therethrough;
a camera unit including
a camera housing having an opening,
an optoelectronic module disposed in said camera housing, and
an electrical wire unit having a first end portion that extends into said camera housing through said opening and that is connected electrically to said optoelectronic module, and a second end portion that extends into said casing;
a coupler for coupling pivotably said camera housing to said casing, said coupler having a first end portion that is received rotatably in said hole in said casing, a second end portion that is coupled to said camera housing, and a flange that is disposed between said first and second end portions of said coupler, said flange of said coupler being provided with a protrusion that is in sliding contact with a periphery of said hole in said casing, said coupler being formed with a hole for extension of said electrical wire unit of said camera unit therethrough; and
a sealing unit for preventing water or vapor from entering said casing, said sealing unit including a first elastic member that surrounds said first end portion of said coupler, that is disposed between and that is in airtight contact with said flange of said coupler and said periphery of said hole in said casing, and that is in sliding contact with said periphery of said hole in said casing.

2. The electronic device as claimed in claim 1, wherein said first elastic member of said sealing unit is provided with a rib that surrounds said first end portion of said coupler and that is in sliding contact with said periphery of said hole in said casing.

3. The electronic device as claimed in claim 1, wherein said sealing unit further includes a second elastic member that surrounds said second end portion of said coupler, and that is disposed between and that is in airtight contact with said flange of said coupler and a periphery of said opening in said camera housing.

4. The electronic device as claimed in claim 1, further comprising a fastening member that extends through said second end portion of said coupler and that threadedly engages said camera housing.

5. The electronic device as claimed in claim 1, wherein said coupler is cylindrical in shape.

6. The electronic device as claimed in claim 1, wherein said coupler and said sealing unit are integrally formed into a single piece.
